(19) United States
(12) Patent Application Publication
(10) Pub. No.: US 2005/0095407 A1
(43) Pub. Date: May 5, 2005

(54) Spaced-apart fresnel lens decorative material and process of manufacturing the material

(76) Inventor: Joseph W. Coburn JR., Jackson, NJ (US)

Correspondence Address: R. GALE RHODES, JR.;MOSER, PATTERSON & SHERIDAN, LLP, Suite 100, 595 Shrewsbury Avenue, Shrewsbury, NJ, 07702, US

(21) Appl. No.: 10/701,230

(22) Filed: Nov. 4, 2003

(51) Int. Cl. B05D 5/06; B41M 5/00

(52) U.S. Cl. 428/195.1; 427/162; 427/256

(57) ABSTRACT

Decorative material embodying the present invention may include a plurality of spaced-apart Fresnel lens. Process of manufacturing such decorative material in accordance with the present invention may include the steps of providing a plurality of Fresnel lens and applying an opaque coating to at least first portions of the Fresnel lens to provide spaced-apart second portions of the Fresnel lens.

### BACKGROUND OF THE INVENTION

This invention relates generally to new and improved decorative material, more particularly relates to new and improved spaced-apart Fresnel lens decorative material, and still more particularly, relates to new and improved spaced-apart Fresnel lens decorative material wherein the Fresnel lens are colored and are separated by an opaque surface or area of the same color or different color than the Fresnel lens. Such decorative material, although not so limited, is particularly useful for packaging. This invention also relates to a new and useful manufacturing process for manufacturing such spaced-apart Fresnel lens, decorative material.

As known to the prior art, and as illustrated. diagrammatically in FIGS. 1-2, Fresnel lens replace the curved surfaces of a conventional lens with a series of concentric grooves, such as the grooves 10, 12, 14 and 16 of FIG. 1, which grooves are typically molded into one surface of a relatively thin layer or sheet of transparent, or at least substantially transparent, plastic 16, such grooves provide a plurality of concentric ridges such as ridges 18, 19, 20 and 22 as illustrated in cross-section in FIG. 2. Such grooves act as individual refracting surfaces, like tiny prisms when viewed in cross-section, bending parallel rays in very close approximation to a common focal length. Because the lens is relatively thin, very little light is lost by absorption.

As is further known to the art, to make Fresnel lens decorative material, the center square portion, such as the square portion 24 of FIG. 1, is cut out and the plurality of such individual squares are assembled to provide a plurality of contiguous Fresnel lens 24 as illustrated diagrammatically in FIG. 3, such plurality of contiguous Fresnel lens are referred to generally by general numerical designation 25. Typically., as is further known, instead of assembling a plurality of individual rectangular Fresnel lens 24, a master or large embossing mold is made which is the negative of the contiguous Fresnel lens 24 pattern shown in FIG. 3. Typically, such embossing mold is then used to mold or emboss the plurality of contiguous Fresnel lens 24 into the top surface of a heated layer of sheet of relatively thin plastic. Such plastic may be, for example, polycarbonate, polyvinylchloride, polyester and the like.

After such molding or embossing, and as is further known to the art, the molded or embossed surface of the layer or sheet of plastic 16, note FIG. 4, provided with the concentric grooves and ridges shown in FIGS. 1 and 2, is metallized, such as for example by aluminum vapor deposition, to provide the reflecting metallized layer 26 shown in FIG. 4. A layer of suitable adhesive 28 is then typically used to adhere the metallized surface to a suitable substrate or layer of backing material 29.

Sheets or layers 25 of such contiguous Fresnel lens 24 illustrated diagrammatically in FIG. 3 are available from Coburn Graphic Film Corporation, of Lakewood, N.J., under the trademark Multi-Lens and are also available from the Spectratek Technologies, Inc. of Los Angeles, Calif., under the trademark or trade name Lens Array. Accordingly, it will be understood that as used hereinafter and in the appending claims, the term “a plurality of contiguous Fresnel lens” shall mean a plurality of contiguous Fresnel lens such as the lens 24 shown in FIG. 3 with or without the metallized layer 26, with or without the layer of adhesive 28, and with or without the layer of backing material 29 shown in FIG. 4.

While the plurality of contiguous Fresnel lens decorative material illustrated in FIG. 3 has received acceptance in the marketplace, it is believed that due to the contiguous and repetitious pattern of the Fresnel lens 24, such decorative material over time comes to provide a less than stimulating visual appearance or impression on the viewer.

Accordingly, it is believed that there is a need in the art for Fresnel lens decorative material providing a more stimulating visual impression or appearance and a manufacturing process for making the same.

### SUMMARY OF THE INVENTION

Decorative material embodying the present invention may include a plurality of spaced-apart Fresnel lens. Process of manufacturing such decorative material in accordance with the present invention may include the steps of providing a plurality of Fresnel lens and applying an opaque coating to at least first portions of the Fresnel lens to provide spaced-apart second portions of the Fresnel lens.

### DESCRIPTION OF THE DRAWINGS

FIG. 1 is a diagrammatical top view of a prior art Fresnel lens;

FIG. 2 is a diagrammatical cross-sectional view taken generally along the line 2-2 in FIG. 1 and in the direction of the arrows;

FIG. 3 is a diagrammatical top perspective top view of prior art decorative material comprised of a plurality of contiguous Fresnel lens;

FIG. 4 is a diagrammatical cross-sectional view taken generally along the line 4-4 in FIG. 3 and in the direction of the arrows;

FIG. 5-9 are representative fragmentary diagrammatical top view illustrations of various embodiments of the present invention including pluralities of spaced-apart Fresnel lens of different geometrical configurations, namely, circular, triangular, star-shaped and hexagonal; and

FIGS. 10-12 are diagrammatical sequential illustrations of a first representative manufacturing process for manufacturing the spaced-apart Fresnel lens decorative material of the present invention, more particularly, FIG. 10 is a top view of a plurality of contiguous Fresnel lens having their central portions masked with triangular masks, FIG. 11 illustrates the application of an opaque coating to the unmasked portions of the plurality of contiguous Fresnel lens shown in FIG. 10, and FIG. 12 illustrates the triangular masks of FIGS. 10 and 11 removed with the spaced-apart Fresnel lens decorative material of the present invention shown provided; and

FIGS. 13-17 are diagrammatical sequential illustrations of a second representative manufacturing process for manufacturing the spaced-apart Fresnel lens decorative material of the present invention, more particularly, FIG. 13 is a top view of alternate embodiment base material, FIG. 14 is a cross-sectional line taken generally along the line 14-14 in FIG. 13 and in the direction of the arrows, FIG. 15 illustrates the central portions of the plurality of Fresnel lens shown in FIG. 13 masked with triangular masks, FIG. 16 illustrates the application of an opaque coating to the unmasked portions shown in FIG. 15 and FIG. 17 illustrates the triangular masks of FIGS. 15 and 16 removed also providing the spaced-apart Fresnel lens decorative material of the present invention.

### DESCRIPTION OF THE PREFERRED EMBODIMENTS

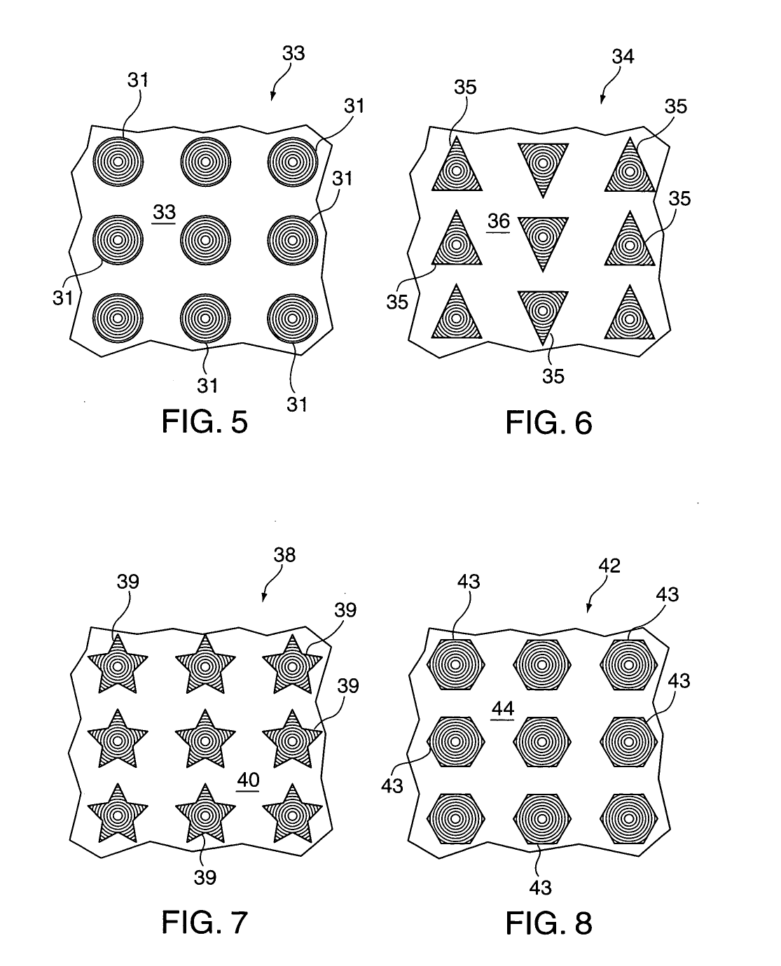

Representative embodiments of the new and improved spaced-apart Fresnel lens decorative material of the present invention are illustrated diagrammatically in FIGS. 5-9 and indicated, respectively, by general numerical designations 30, 34, 38, 42 and 46. It will be understood generally that these representative invention embodiments are embodied as a plurality of spaced-apart Fresnel lens of varying geometrical configurations.

It will be further understood in accordance with the teachings of the present invention, and referring by way of example to FIG. 5, that the spaced-apart circular Fresnel lens 31 of the embodiment 30 are separated a plain smooth continuous opaque surface area 33 which may be glossy or matte in finish. Alternatively, the surface area 33 may be merely opaque, may be plain and opaque, may be plain, smooth and opaque or may be provided by the process known to the art as embossed coated separation. Still further, it will be understood, that the separating opaque surface area 33 may be provided with some ornamentation such as an embossed design or pattern, other than the Fresnel lens, to provide a contrast to the Fresnel lens. Further, the circular spaced-apart Fresnel lens 31 of FIG. 5, by way of further example, may be provided, such as by molding, in a layer of relatively thin plastic sheet or layer such as layer 16 shown in FIG. 4 and which plastic layer may be a layer of transparent plastic colored so as to provide a plurality of colored spaced-apart Fresnel lens. Accordingly, it will be further understood in accordance with the teachings of the present invention, that the plurality of spaced-part Fresnel lens 31 of FIG. 5 may be of a first color and the separating opaque area or surface 33 may be of the same or a different color for contrast. For example, in one embodiment of the present invention of FIG. 5, the spaced-apart circular Fresnel lens 31 of FIG. 5 were yellow and the separating surface or area 33 was white matte. Various other color combinations may be used and are contemplated by the present invention. It will be further understood that the embodiment 30 of the present invention may further include the metallized layer 26, the layer of adhesive 28 and the backing layer 29 shown in FIG. 4.

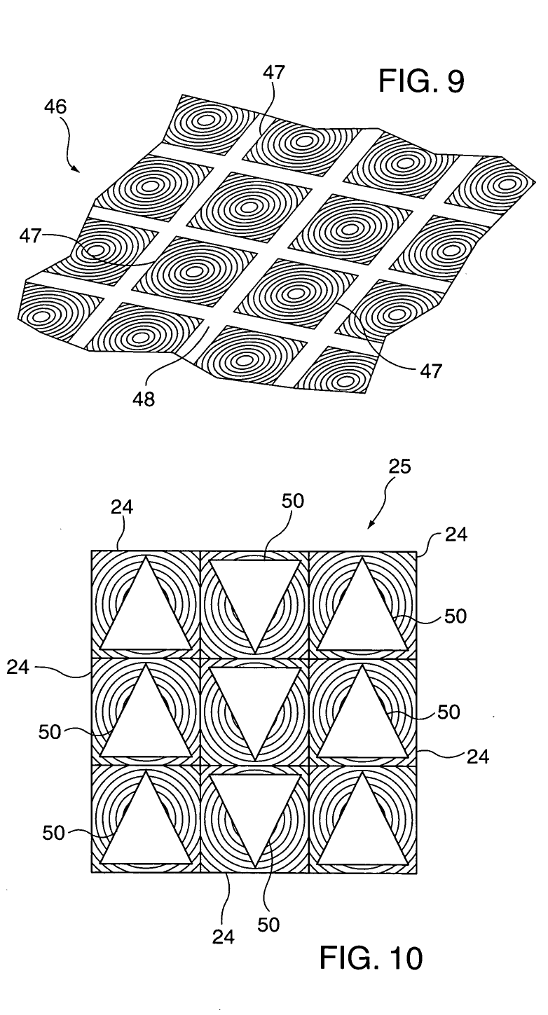

The invention embodiment 34 of FIG. 6 includes a plurality of spaced-apart triangular Fresnel lens 35 separated by an opaque surface or area 36. In the embodiment 38 of FIG. 7, a plurality of spaced-apart star-shaped Fresnel lens are provided separated by an opaque surface 40. In FIG. 8, the invention embodiment 42 is comprised of a plurality of spaced-apart hexagonal Fresnel lens 43 separated by an opaque surface 44. FIG. 9 illustrates the invention embodiment 46 which includes a plurality of spaced apart rectangular Fresnel lens 47 separated by an opaque surface 48. It will be understood that the invention embodiments of FIGS. 6-9 may also include the metallized layer 26, the layer of adhesive 28 and the backing layer 29 shown in FIG. 4.

While spaced-apart Fresnel lens in the shape of circles are shown in FIG. 5, triangles in FIG. 6, stars in FIG. 7, hexagons in FIG. 8, and squares or rectangles in FIG. 9, it will be further understood, that in accordance with the present invention, other geometrically shaped spaced-apart Fresnel lens may be utilized. The spaced-apart Fresnel lens decorative material embodiments of FIGS. 5-9 may be made by the following manufacturing process of the present invention. Generally, a base material such as the contiguous Fresnel lens 24 illustrated diagrammatically in FIG. 3 are provided and an opaque coating is applied over first portions of such contiguous Fresnel lens to provide a plurality of spaced-apart second portions of such Fresnel lens which second portions provide the spaced-apart Fresnel lens of the present invention. The opaque coating provides the solid or plain area 33 shown in FIG. 5 which separates and provides the plurality of spaced-apart circular Fresnel lens 31. Such coating may be applied by suitable coating processes known to the art, such as for example, screen printing, offset printing, or such coating may be applied by the flexographic or rotogravure processes known to the art. And, in the manner known to the art, mats or screens are provided in the appropriate shapes to provide the different geometrical configurations such as shown in FIGS. 5-9.

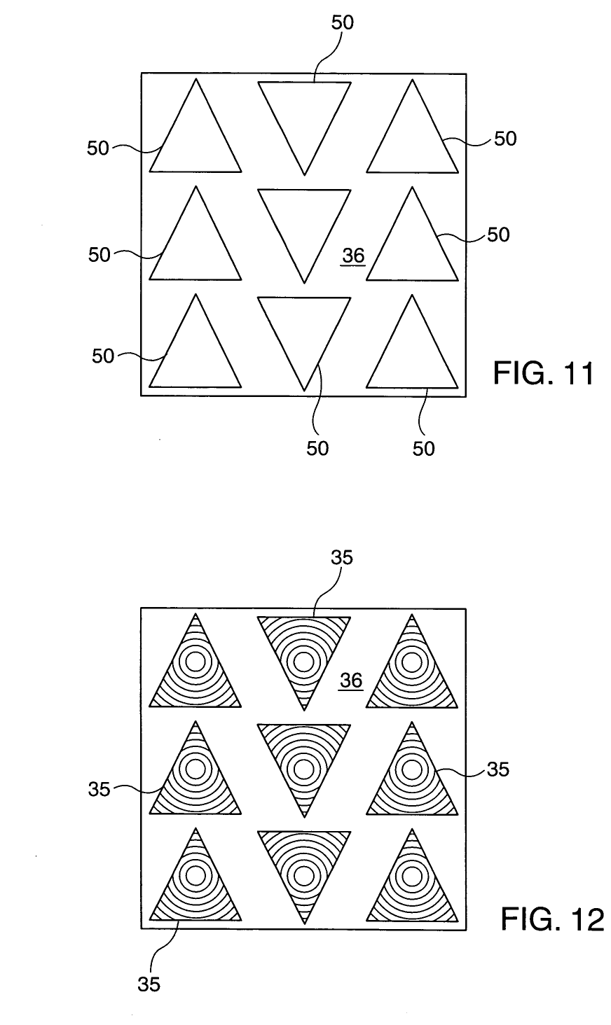

More specifically with regard to the manufacturing process of the present invention, the manufacturing process for manufacturing the invention embodiment 34 of FIG. 6 will be described but will be understood to be representative for the manufacturing process for all the embodiments of the present invention. As illustrated in FIG. 10, a plurality of contiguous Fresnel lens 24 is provided and the plurality of grooves and ridges comprising the center portions of the individual Fresnel lens 24 are covered with suitable triangular masks 50. Thereafter, the un-masked outer portions of the plurality of grooves and ridges comprising the individual Fresnel lens 24 are covered by applying an opaque coating to such un-masked outer portions to provide the opaque portion indicated by general numerical designation 36 in FIG. 11. Thereafter, as illustrated in FIG. 12, the triangular masks 50 of FIGS. 10 and 11 are removed and the plurality of spaced-apart triangular Fresnel lens 35 are provided as shown in FIG. 12 separated by the opaque surface or area 36. As noted above, the separating surface or area 36 may be merely an opaque surface or area, a plain opaque surface or area, a plain smooth opaque surface or area or may be provided with some ornamentation as noted above.

It has been found that the plurality of spaced-apart Fresnel lens shown in FIGS. 5-9 provide a visually more visually stimulating appearance or impression than plurality of contiguous Fresnel lens 24 of the prior art as illustrated in FIG. 3.

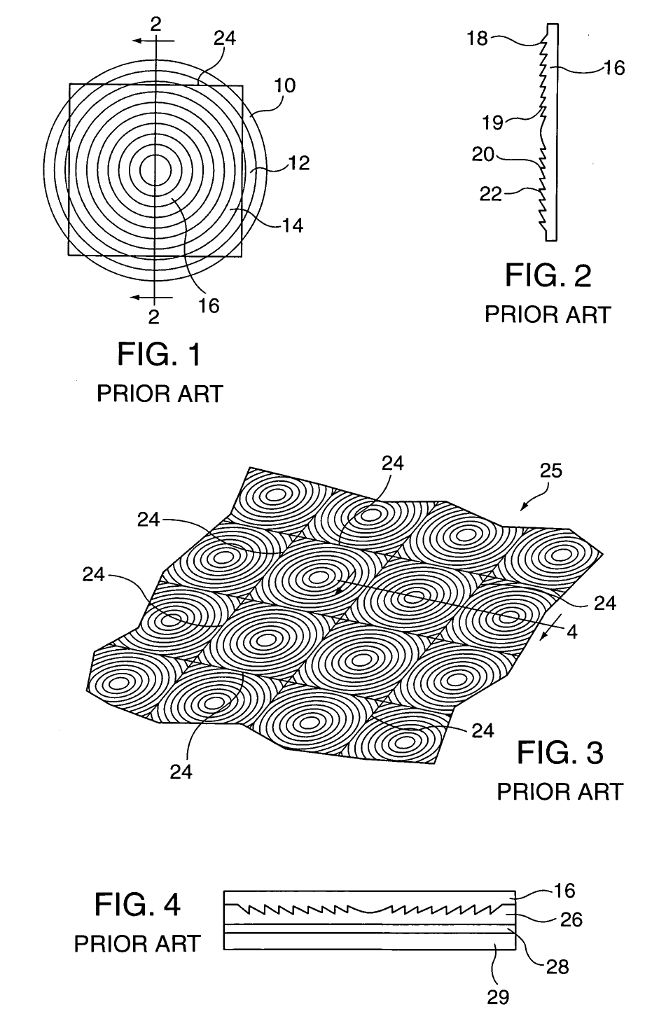

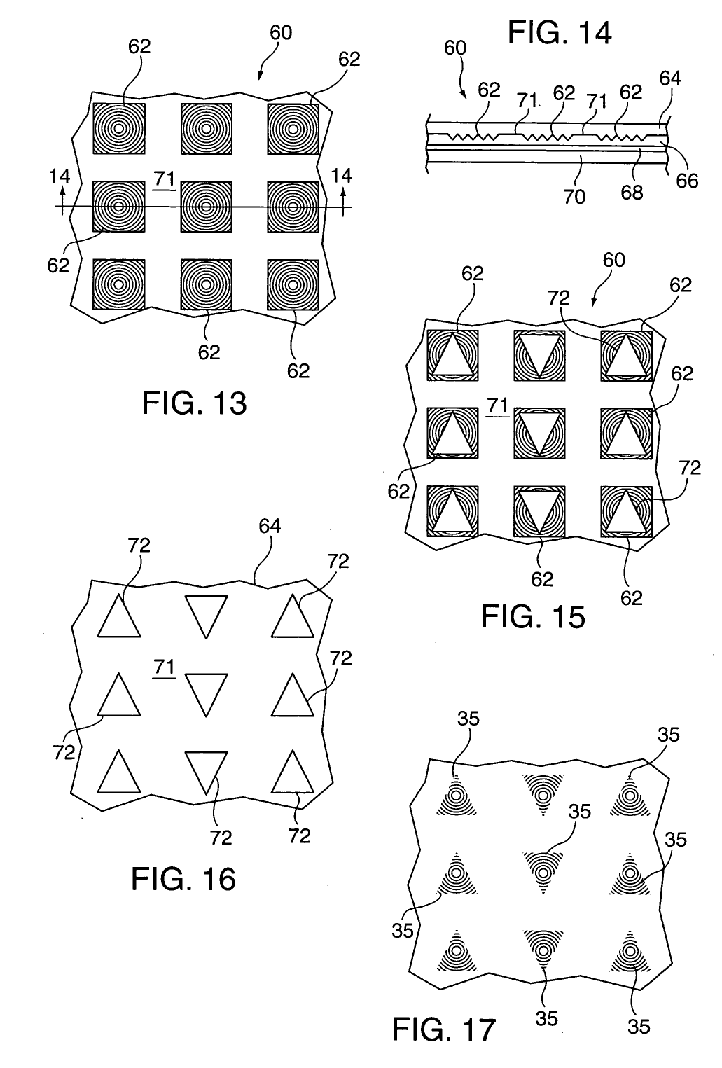

An alternate process for manufacturing the spaced-apart Fresnel lens decorative material of the present invention is illustrated diagrammatically in FIGS. 13-17. Referring first to FIGS. 13 and 14, a base material indicated by general numerical 60 is provided which includes a plurality of Fresnel lens 62 comprised of the concentric grooves 10, 12, 14 and 16 and the ridges 18, 19, 20 and 22 shown in FIGS. 1 and 2 and described above; for convenience and clarity of presentation, and due to their closeness, such grooves and ridges are not identified numerically in FIG. 13. As illustrated in FIG. 14, the base material 60 may include a sheet or layer of suitable transparent, or at least substantially transparent, plastic 64 into the bottom surface of which the plurality of Fresnel lens 62 are molded or embossed. The lower embossed or molded surface of the plastic 64 is suitably metallized with a layer of metallization 66 and a suitable layer of adhesive 68 may be provided to adhere the metallized layer 66 to a suitable substrate or layer of backing material 70. Referring again to FIGS. 13 and 14, light striking the Fresnel lens 62 will provide the Fresnel lens effect but light striking the un-embossed or non-molded portions 71 of the transparent, or least substantially transparent layer of plastic 64, will be reflected back by the metallized layer 66 underlying the un-embossed portions 71 and such light may be observed by a viewer. The plastic layer 64 may be transparent colored plastic.

Referring now to FIGS. 15-17, the alternate embodiment manufacturing process of the present invention will be described representatively as also being for manufacturing the triangularly shaped spaced-apart Fresnel lens 35 of FIG. 6 but will be understood to be equally applicable for manufacturing the other embodiments. Accordingly, as illustrated in FIG. 15, the central portions of the plurality of Fresnel lens 62 are covered with triangular masks 72 to mask the underlying concentric grooves and ridges. Thereafter, as illustrated in FIG. 16, a suitable opaque coating is applied to the un-embossed or un-molded portion 71 of the top surface of layer of plastic 64 and to the unmasked portions of the Fresnel lens 62 shown in FIG. 15. Such opaque coating 71 may be an opaque coating, a plain opaque coating or an ornamented opaque coating as described above. Thereafter, as illustrated in FIG. 17, the triangular masks 72 of FIGS. 15 and 16 are removed thereby exposing to view the previously masked concentric grooves and ridges comprising the triangular central portions of the Fresnel lens 62 of FIG. 13, thereby, providing the plurality of spaced-apart triangular Fresnel lens 35 of FIG. 6 separated by the e.g. opaque coating 71. As in the earlier embodiments, the triangular Fresnel lens 35 may be of one color and the opaque coating 71 of the same or a different color.

It will be understood that many variations and modifications may be made in the present invention without departing from the spirit and scope thereof.

1. Decorative material comprising a plurality of spaced-apart Fresnel lens of a pre-determined geometrical configuration separated by an opaque surface.

2. The decorative material according to claim 1 wherein said opaque surface has a glossy finish.

3. The decorative material according to claim 1 wherein said opaque surface has a matte finish.

4. The decorative material according to claim 1 wherein said plurality of spaced-apart Fresnel lens are of a first color and wherein said opaque surface is of a second color.

5. The decorative material according to claim 1 wherein said opaque surface is a plain opaque area.

6. The decorative material according to claim 5 wherein said plain opaque surface is a plain smooth opaque area.

7. The decorative material according to claim 1 wherein said opaque surface is provided with ornamentation other than Fresnel lens.

8. Process of manufacturing decorative material comprising the steps of providing a plurality of Fresnel lens and applying an opaque coating to at least first portions of said Fresnel lens to provide spaced-apart second portions of said Fresnel lens separated by an opaque surface.

9. The process according to claim 8 wherein said step of applying said opaque coating is the step of applying a plain opaque coating.

10. The process according to claim 9 wherein said step of applying said plain opaque coating is the step of applying a plain smooth opaque coating.

11. The process according to claim 8 wherein said step of applying said opaque coating is the step of applying an opaque coating provided with ornamentation other than Fresnel lens.

12. The process according to claim 8 wherein said step of providing a plurality of Fresnel lens is the step of providing a plurality of contiguous Fresnel lens of a first color and wherein said applying step is the step of applying an opaque coating of a second color to said first portions of said Fresnel lens of said first color to provide spaced-apart second portions of said Fresnel lens of said first color separated by an opaque coating-of said second color.

13. The process according to claim 12 wherein said step of providing a plurality of Fresnel lens is the step of providing a plurality of contiguous Fresnel lens of a first color and wherein said applying step is the step of applying an opaque coating of a second color to said first portion of said plurality of contiguous Fresnel lens of said first color to provide spaced-apart second portions of said plurality of contiguous Fresnel lens of said first color separated by said opaque coating of said second color.

14. The process according to claim 8 wherein said step of applying said opaque coating is the step of silk screen printing said opaque coating.

15. The process according to claim 8 wherein said step of applying said opaque coating is the step of offset printing said opaque coating.

16. The process according to claim 8 wherein said step of applying said opaque coating is the step of applying said opaque coating by the rotogravure process.

17. The process according to claim 8 wherein said step of applying said opaque coating is the step of flexographic printing of said opaque coating.

18. The process according to claim 8 wherein said step of applying said opaque coating is the step of ink jet printing said opaque coating.
